(19) United States
(12) Patent Application Publication
(10) Pub. No.: US 2004/0149967 A1
(43) Pub. Date: Aug. 5, 2004

(54) Pry bar

(76) Inventors: Robert Puopolo, Evertt, MA (US); David Tassinari, Medford, MA (US)

Correspondence Address: ALTMAN & MARTIN, 6 BEACON ST, STE 600, BOSTON, MA, 02108, US

(21) Appl. No.: 10/795,531

(22) Filed: Mar. 8, 2004

(51) Int. Cl. B66F 15/00

(52) U.S. Cl. 254/25

(57) ABSTRACT

A pry bar composed of an elongated rod with a bevel at one end and a non-slip handle at the other end. The bevel is at an angle of from 5° to 12° from the rod axis. The bevel face is scored to minimize slippage. In one embodiment, the scoring includes one or more grooves extend completely across the bevel face approximately perpendicularly to the rod axis. The preferred groove cross section is semicircular cross section with a depth in the range of 1/32 inch to 1/4 inch. In another embodiment, the scoring includes cross-hatched grooves.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates to pry bars, more particularly, to a heavy duty pry bar for vehicle, heavy equipment, construction, and related uses.

2. Description of the Related Art

When performing maintenance and repairs on automobiles and other vehicles, it is occasionally necessary to apply leverage to vehicle components. The present applicant has observed that such workers typically use pinch bars. Pinch bars are not designed for such work for a number of reasons. They do not have a surface designed for prying vehicle or other similar articles, they do not have handles designed for a grip appropriate to these situations, and they may not be the appropriate length.

### BRIEF SUMMARY OF THE INVENTION

An object of the present invention is to provide a pry bar that has a surface designed minimized slippage between the pry bar and the item being pried.

The present invention is a pry bar composed of an elongated rod with a bevel at an operative end. Preferably the operative end is blunt rather pointed. The bevel angle is in the range of from 5° to 12° from the axis of the rod. The distance that face extends from the operative end is in the range of approximately 3 1/4 inches to approximately 10 inches. The operative end can taper to a point for special applications.

The bevel face is scored to minimize slippage. In one embodiment, the scoring includes one or more grooves extending completely across the face approximately perpendicularly to the rod axis. The groove has no bends as it extends across the face. The groove provides a grip for a vehicle component being pried. The groove cross section can be any shape and/or size, but a semicircular cross section is preferred because it allows the vehicle component to pivot within the groove and because it leaves the pry bar stronger and less likely to bend at the groove. The minimum groove depth is about 1/32 inch and the maximum depth dependents upon the remainder of the pry bar parameters but will typically be approximately 1/4 inch.

In another embodiment, the scoring takes the form of cross-hatched grooves.

The other end of the pry bar has a handle that is preferably non-slip because the hands of a person working on a vehicle are likely to be greasy or oily. Various methods of providing a non-slip handle are contemplated, including knurling, texturing, and rubber or plastic overlays.

Other objects of the present invention will become apparent in light of the following drawings and detailed description of the invention.

### BRIEF DESCRIPTION OF THE DRAWINGS

For a fuller understanding of the nature and object of the present invention, reference is made to the accompanying drawings, wherein:

FIG. 1 is a perspective view of the pry bar of the present invention;

FIG. 2 is a side view of one embodiment of the operative end of the pry bar of FIG. 1;

FIG. 3 is a top view of the operative end of the pry bar of FIG. 2; and

FIG. 4 is a top view of another embodiment of the operative end of the pry bar of FIG. 1.

### DETAILED DESCRIPTION OF THE INVENTION

The present invention is a pry bar designed for automotive and vehicular applications, although it is usable in other applications as desired. The present specification refers to automotive applications, but it is understood that other applications are contemplated.

The pry bar 10 of the present invention, shown in the figures, is an elongated rod 12 of rigid material. The rod 12 is beveled such that the bevel face 14 extends from the operative end 18 of the rod 12 at a small angle 16 to the axis 22 of the rod 12. Preferably, the operative end 18 of the rod 12 is blunt, rather than coming to a point.

The dimensions of one configuration of the face 14 are shown in FIGS. 2 and 3. The face 14 has a bevel angle 16 of approximately 8½° to the rod axis 22 and extends approximately 6 1/4 inches from the operative end 18, as at 24. This means that the operative end 18, which is a circle segment, has a height 26 of approximately 3/8 inch. The present invention contemplates that the bevel angle 16 can range from approximately 5° to approximately 120. An angle less than 5° would make the operative end 18 too thick to fit into tight spaces and an angle greater than 12° would make the tip of the bar too weak.

The distance 24 from the operative end 18 that the face 14 extends can range from approximately 3 1/4 inches to approximately 10 inches. A length of less than 3 1/4 inches would make much of the face 14 unavailable when prying small areas and a length greater than 10 inches would make the tip too weak.

The present invention contemplates that the operative end 18 can taper to a point for special applications. However, a point would typically be too weak for normal usage.

The bevel face 14 is scored, as at 30, to minimize slippage between the pry bar 10 and the item being pried. Although the present specification describes only two configurations for the scoring 30, the present invention contemplates that the use of any method of scoring that minimizes slippage.

In one embodiment, shown in FIGS. 2 and 3, the scoring 30 takes the form of at least one groove 32 extending approximately transversely completely across the face 14, where “transverse” means perpendicular to the rod axis 22. The groove 32 is linear, that is, it extends across the face 14 with no bends. It extends “approximately” transversely because there may be situations where the pry bar 10 is more useful if the groove 32 was not perpendicular to the rod axis 22, but at a small angle from perpendicular.

The groove 32 provides a grip for a vehicle component being pried. An edge of the component wedges or catches in the groove 32 so that it does not slip relative to the pry bar 10. There may be more than one groove 32, as in the figures, where the grooves 32 are spaced apart to provide different amounts of leverage and/or to fit into narrower or wider openings. Multiple grooves 32 also provides a measure of safety in that if the vehicle component slips out of one groove 32, it can be caught by another groove 32. The configuration of FIG. 2 shows three grooves 32 with semicircular cross sections and a diameter of 3/32 inch. The cross section can be any shape and/or size that the vehicle component can wedge into, such as rectangular or triangular. There are limits to the depth of the groove 32. The minimum depth is about 1/32 inch. Any shallower and the groove 32 will not provide an adequate grip to the component being pried. The maximum depth depends upon the diameter 28 of the pry bar 10, but will typically be approximately 1/4 inch in order to minimize the tendency of the pry bar 10 to bend at the groove 32. A semicircular cross section is preferred because it allows the vehicle component to pivot within the groove 32 with a minimal potential of damage to the component. The semicircular cross section is also preferred because it leaves the pry bar 10 stronger and less likely to bend at the groove 32 than with cross sections that have sharp corners, such as rectangular and triangular cross sections.

In another embodiment, shown in FIG. 4, the scoring 30 takes the form of cross-hatched grooves 34 extending over a portion or the face 14.

The required strength of the material depends upon the dimensions of the pry bar 10. There are two current configurations of the pry bar. The first configuration is 42 inches long with a circular cross section having a 1-inch diameter. The second configuration is 60 inches long with a circular cross section having a 1-1/4-inch diameter. The length of the pry bar 10 depends upon the application. However, a length shorter than 24 inches does not provide enough leverage for the typical use and a length greater than 72 inches becomes awkward and heavy to handle. The circular cross section is not required, but is merely a convenience in that is easy to grip. Other cross sections that are more appropriate for a particular need are contemplated by the present invention.

Both of the current configurations are composed of low-carbon steel 1018, which has a carbon content in the range of 0.15% to 0.21%. This steel is considered to be of low strength, but is easily worked. Weaker materials can be used where a shorter and/or thicker pry bar is acceptable. Stronger materials can be used where a longer, thinner, and/or lighter pry bar is desired. Other materials include, but are not limited to, other steels and composite materials.

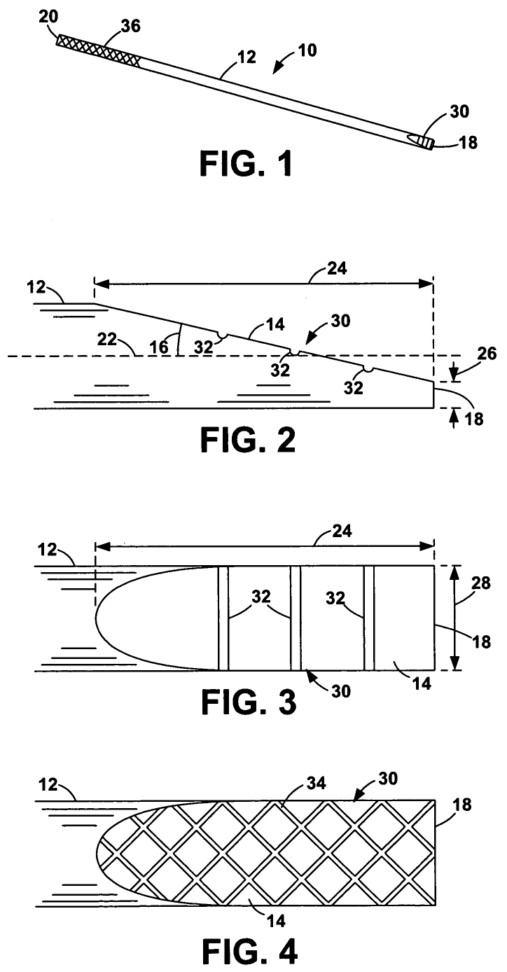

Extending from the handle end 20 of the rod 12 is handle 36 that is preferably non-slip because the hands of a person working on a vehicle are likely to be greasy or oily. Preferably, the handle 36 is knurled, as in FIG. 1, but other means for making the handle 26 non-slip are contemplated by the present invention. Other means include, but are not limited to, a roughly textured surface, a rubber or plastic overlay that is formed and slid onto the handle, and a rubber or plastic overlay that is dipped and hardened in place.

Thus it has been shown and described a pry bar which satisfies the objects set forth above.

Since certain changes may be made in the present disclosure without departing from the scope of the present invention, it is intended that all matter described in the foregoing specification and shown in the accompanying drawings be interpreted as illustrative and not in a limiting sense.

I claim:

1. A pry bar comprising:
(a) an elongated rod of rigid material having an operative end, a handle end, and an axis;
(b) a bevel extending from said operative end with a face at a small angle to said axis; and
(c) scoring on at least a portion of said face.

2. The pry bar of claim 1 wherein said scoring includes at least one groove extending transversely across said face approximately parallel to said rod axis.

3. The pry bar of claim 2 wherein said at least one groove is linear across said face.

4. The pry bar of claim 2 wherein said at least one groove has an approximately semicircular cross section.

5. The pry bar of claim 2 wherein said at least one groove has a depth in the range of approximately 1/32 inch to approximately 1/4 inch.

6. The pry bar of claim 1 wherein said scoring includes a plurality of cross-hatched grooves.

7. The pry bar of claim 1 wherein said angle is in the range of approximately 5 degrees to approximately 12 degrees.

8. The pry bar of claim 1 wherein said operative end is blunt.

9. The pry bar of claim 1 wherein a non-slip handle extends from said handle end.

10. The pry bar of claim 9 wherein said handle is knurled.

11. The pry bar of claim 1 wherein said rod is composed substantially of steel.

12. The pry bar of claim 1 wherein said pry bar has a length of between approximately 24 inches and approximately 72 inches.

13. A pry bar comprising:
(a) an elongated rod of rigid material having an operative end, a handle end, and an axis;
(b) a bevel extending from said operative end with a face at a small angle to said axis;
(c) at least one linear groove extending transversely across said face approximately parallel to said rod axis; and
(d) a non-slip handle extending from said handle end.

14. The pry bar of claim 13 wherein said at least one groove has an approximately semicircular cross section.

15. The pry bar of claim 13 wherein said at least one groove has a depth in the range of approximately 1/32 inch to approximately 1/4 inch.

16. The pry bar of claim 13 wherein said angle is in the range of approximately 5 degrees to approximately 12 degrees.

17. The pry bar of claim 13 wherein said operative end is blunt.

18. The pry bar of claim 13 wherein said rod is composed substantially of steel.

19. The pry bar of claim 13 wherein said handle is knurled.

20. A pry bar comprising:
(a) an elongated rod composed substantially of steel having a blunt operative end, a handle end, and an axis;
(b) a bevel extending from said operative end with a face at an angle to said axis in the range of approximately 5 degrees to approximately 12 degrees; and
(c) at least one linear groove extending transversely across said face approximately parallel to said rod axis; and
(d) a knurled handle extending from said handle end.
